(19) United States
(12) Patent Application Publication
(10) Pub. No.: US 2016/0245340 A1
(43) Pub. Date: Aug. 25, 2016

(54) CENTRIFUGAL DISK AS A PRE-SEAL FOR A WHEEL BEARING

(71) Applicant: SCHAEFFLER TECHNOLOGIES AG & CO. KG, Herzogenaurach (DE)

(72) Inventors: Andreas Kaiser, Werneck (DE); Roland Langer, Schwanfeld (DE); Frank Eichelmann, Donnersdorf (DE); Tobias Bauer, Gochsheim (DE); Markus Reuter, Wurzburg (DE); Ralf Heiss, Schweinfurt (DE); Jonas Lang, Schwebheim (DE)

(73) Assignee: Schaeffler Technologies AG & Co. KG, Herzogenaurach (DE)

(21) Appl. No.: 15/025,721

(22) PCT Filed: Jul. 30, 2014
(86) PCT No.: PCT/DE2014/200365

§ 371 Date: Mar. 29, 2016

(30) Foreign Application Priority Data
Oct. 2, 2013 (DE) 10 2013 220 074.9

(51) Int. Cl. F16C 33/80; F16C 33/78

(52) U.S. Cl. CPC F16C 33/805; F16C 33/7823; F16C 33/7876; F16C 33/7863; F16C 2326/02

(57) ABSTRACT

The invention relates to a seal arrangement for a wheel bearing, inserted between a first bearing part and a second bearing part of the wheel bearing, which includes a pre-seal designed as a centrifugal disk and a seal set having sealing lips and a reinforcement. The seal set is attached to the first, torsionally fixed bearing part by a reinforcement which is surrounded at least partially by an elastic sealing material. A radial edge of a centrifugal disk engages with play in an opening that is delimited radially by the sealing material, said centrifugal disk being fixed to the second bearing part via a radial leg and including a catch groove. Together with the seal set, the centrifugal disk forms a seal labyrinth.

### BACKGROUND

The invention relates to a seal arrangement of a wheel bearing, which is inserted between a first bearing part and a second bearing part of the wheel bearing. Here the seal arrangement comprises a pre-seal embodied as a centrifugal disk, together with a seal set comprising sealing lips and a reinforcement. The reinforcement of the seal set is connected to the first, torsionally fixed bearing part and at least partially enclosed by an elastic sealing material, which forms a radially defined socket. The pre-seal fixed to the second bearing part is embodied as a centrifugal disk and forms a catch groove, and engages with a degree of play in the socket formed by the sealing material. A radial edge of the centrifugal disk running here maintains a seal gap in relation to the seal set.

Seal arrangements with rubbing seal contacts of sealing lips and non-rubbing sealing lips for sealing off antifriction bearings are known from a variety of applications in wheel bearings for vehicles.

JP 2003-56577 A discloses a seal for a wheel bearing in which the outer ring, as first bearing part, is sealed off from the wheel flange, as second bearing part. The wheel bearing seal encloses a centrifugal plate, which rests both axially and radially on the wheel hub and the wheel flange. In the fitted state axial sealing lips are supported by rubbing seal contacts against the centrifugal plate. The sealing lips are assigned to a carrier, which is fixed to a radial inner side of the outer ring. DE 10 2009 052 311 A1 discloses a wheel bearing, the flange-side centrifugal disk of which forms axial faces for a rubbing seal contact of two axial sealing lips. On the wheel flange side, the fixing area of the centrifugal disk in a transitional area forms a radially extending portion.

### SUMMARY

The object of the invention is to create an effective seal arrangement for wheel bearings which is easy to assemble and cost-effective to manufacture.

This object is achieved by a seal arrangement having the features of the invention. Advantageous developments of the invention are described below.

The construction of the seal arrangement according to the invention comprises a pre-seal constructed in one piece as a centrifugal disk, which is fixed in position on a radially oriented annual flange of the second, rotatable bearing part of the wheel bearing by a radial leg. Together with the seal set of the seal arrangement the pre-seal forms a seal labyrinth having a defined inlet gap, wherein a radial edge of the centrifugal disk runs while maintaining a seal gap in relation to the seal set. According to the design concept of the seal arrangement according to the invention, the sealing lips are not supported on the centrifugal disk and the pre-seal but directly on the rotating bearing part. Consequently, in contrast to known, existing solutions, a centrifugal disk of a non-corroding material can advantageously be dispensed with. The invention affords a further cost advantage, since this obviates the need for any sealing, for example by means of a sealing compound, for a seal gap occurring between the annular flange of the rotating bearing part and the leg of the centrifugal disk. Moreover, the invention advantageously allows the creation of a low-friction torque (LFT) seal arrangement. In addition, the invention affords scope for enlarging a transition radius between the radially oriented flange and the axially running portion of the rotating second bearing part, in order to improve the component rigidity of the second bearing part connected to the vehicle wheel. At the same time, it is thereby advantageously possible to achieve a compact, robust bearing construction. The invention makes it possible to increase both the service life and the sealing efficiency of a seal arrangement based on sealing lips and a centrifugal disk, without forfeiting any advantages of the known, conventional seal arrangements.

According to a preferred development of the invention a centrifugal disk having a U-shaped cross sectional profile is provided. Here the radial leg of the centrifugal disk runs parallel to the associated edge, which together laterally define the catch groove. Alternatively, according to the invention the centrifugal disk may have a Z-shaped cross sectional profile, wherein the radial leg is oriented in opposition to the edge of the centrifugal disk. In the fitted state of the centrifugal disk having the Z-shaped cross sectional profile, the catch groove is defined by the radial annular flange of the second bearing part and the edge of the centrifugal disk.

In order to form a seal labyrinth of the seal arrangement, the edge of the centrifugal disk, whilst maintaining a seal gap, engages in an axial socket of the seal set. Here the socket is defined radially by a projection and sealing lips formed from the elastic sealing material.

In order to ensure a durable positional fixing of the centrifugal disk on the annular flange of the rotatable, second bearing part, the radial leg of the centrifugal disk may be fixed to the annular flange by a cohesive material connection, especially by an adhesive bond. A further possibility that presents itself is to fix the leg to the annular flange by positive interlock in order to center and fix the centrifugal disk. For this purpose, for example, the centrifugal disk may be fitted into a step or recess of the radially oriented annular flange of the second, rotatable bearing part. In the case of an alternative, positively interlocking fixing, the annular flange of the second, rotatable bearing part locally comprises at least one projecting formed attachment, which engages in a corresponding formation of the leg of the centrifugal disk. In order to ensure a durable bond between the annular flange and the centrifugal disk, it is also possible, where necessary, to fix the centrifugal disk to the annular flange by a combined cohesive material and positively interlocking connection.

In order to ensure a durable bond of the seal set, its reinforcement non-positively and externally encloses an end portion of the first bearing part with an angled leg, forming a sleeve portion. This measure serves to fix the reinforcement in its fitted position and at the same time to fix the seal set in relation to the first bearing part, which may also be referred to as an outer bearing ring.

The seal arrangement according to the invention also makes provision for coating the reinforcement of the seal set with a sealing material on one side, in at least some areas. The angled leg of the reinforcement forming a sleeve portion is preferably fully enclosed by the elastic sealing material. In particular, an elastomer, which serves to form protruding, elastic sealing lips and/or projections, is provided as elastic sealing material. A first, largely axially oriented projection formed from the sealing material overlaps the catch groove on the opening side and is taken up to an annular gap on the annular flange of the first bearing part. The seal set includes multiple sealing lips or projections, positioned beneath the centrifugal disk and likewise formed from the sealing material, which are oriented for rubbing contact or non-contact with the second bearing part, advantageously with a radial offset in relation to the projection. A sealing lip running largely axially, to which a non-rubbing sealing lip is assigned on both sides, is preferably supported on the radial flange of the second bearing part. A radially oriented sealing lip is led up to a gap dimension on an axially running portion of the second bearing part. A further non-rubbing sealing lip is positioned between the centrifugal disk and the rubbing sealing lip. At the end this sealing lip has a fold pointing towards the centrifugal disk, thereby forming a collecting channel.

According to a preferred development the centrifugal disk and the reinforcement are produced from a metallic material. As an alternative to a rustproof material, a sheet steel may be used, for example, the surfaces of which are treated or coated. In addition, a centrifugal disk comprised of plastics may be used, or a sheet-metal ring or a cylindrical steel sleeve, on to which a plastic leg is molded, may be used as centrifugal disk.

### BRIEF DESCRIPTION OF THE DRAWINGS

Further features of the invention emerge from the following description and from the drawings, in which exemplary embodiments of the invention are represented. The embodiments represented show examples of how the seal arrangement according to the invention can be configured. They do not conclusively limit the invention, which is not confined to these exemplary embodiments. In the drawings:

FIG. 1 shows a first embodiment of a seal arrangement according to the invention in connection with a wheel bearing;

FIG. 2 shows a second embodiment of a seal arrangement according to the invention;

FIG. 3 shows a third embodiment of a seal arrangement according to the invention;

FIG. 4 shows a fourth embodiment of a seal arrangement according to the invention; and

FIG. 5 shows a fifth embodiment of a seal arrangement according to the invention;

### DETAILED DESCRIPTION OF THE PREFERRED EMBODIMENTS

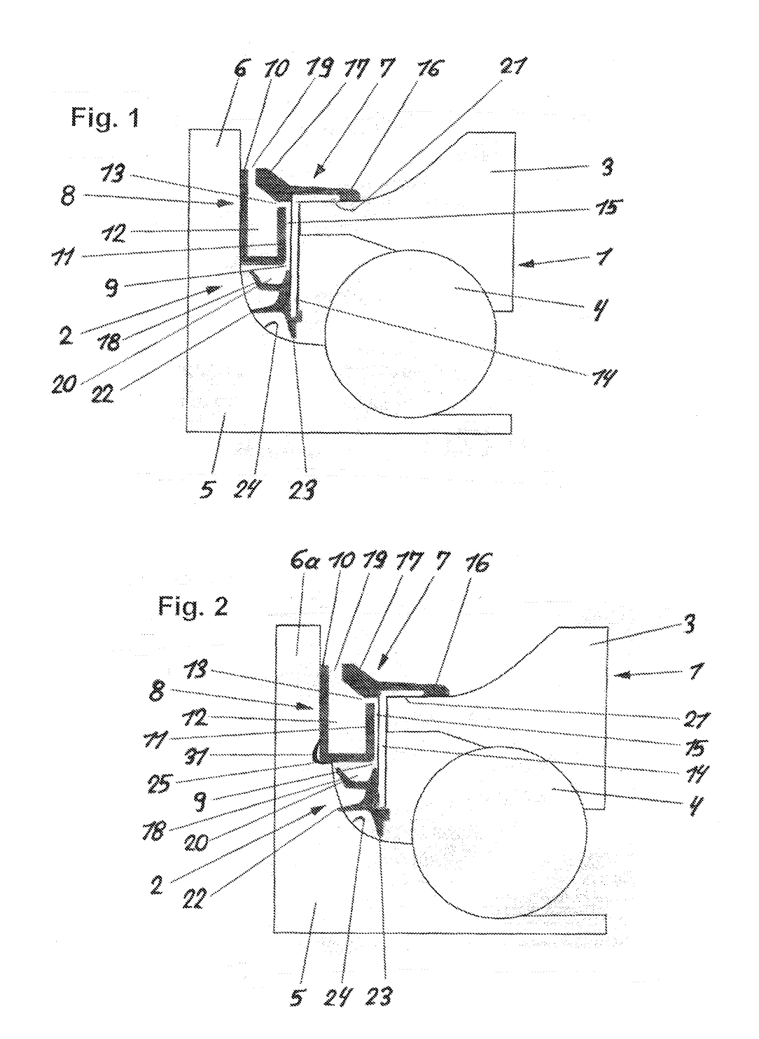

FIG. 1 shows a detail of a wheel bearing 1 embodied as an antifriction bearing and illustrates the construction of a seal arrangement 2 on the wheel side. The wheel bearing 1 comprises a first bearing part 3, an outer, fixedly positioned bearing ring, which in the fitted state is connected to a wheel carrier (not shown). Rolling elements 4 are guided on the outside on the bearing part 3 and on the inside on a second bearing part 5, an inner bearing ring, which is integrally connected to a radially oriented annular flange 6. The seal arrangement 2 comprises a seal set 7, assigned to the first bearing part 3, and as pre-seal a frictionless centrifugal disk 8. The centrifugal disk 8 forming a seal labyrinth 9 together with the seal set 7 has a U-shaped cross sectional profile. A cohesive material connection, for example adhesive bonding, serves to fix the position of a circumferential leg 10 of the centrifugal disk 8 on the radially oriented annular flange 6. An externally open catch groove 12 of the centrifugal disk 8 is axially defined by the leg 10 and an edge 11. To form the seal labyrinth 9, the edge 11 of the centrifugal disk 8, while maintaining a seal gap 13, engages in an axial socket 15 of the seal set 7, which is defined radially by a projection 17 and a sealing lip 18. The projection 17 and the sealing lip 18 are correspondingly formed from an elastic sealing material 16, which covers a reinforcement 14 of the seal set 7 at least to a limited degree. To fix the reinforcement 14 and consequently the seal set 7, an angled portion 21 of the reinforcement 14 locally encloses an external contour of the first bearing part 1. The projection 17, offset at the end, largely covers an opening of the catch groove 12 of the centrifugal disk 8 and is led up to an annular gap 19 at the leg 10 of the centrifugal disk 8. In service, the centrifugal disk 8 serves to deflect both water and dirt particles radially, so as to keep these away from the seal gap 13 of the seal labyrinth 9. The sealing lip 18 forms a collecting channel 20 downstream of the catch groove 12 of the centrifugal disk 8, the channel being fixed, unlike the catch groove 12, which rotates in operation. A liquid entering the collecting channel 20, for example, passes unimpeded, under gravitational force, in a vertical direction to the lowest zone of the collecting channel 20, and thence to the inside of the centrifugal disk 8. Under centrifugal force the liquid is then delivered radially outwards by the rotating centrifugal disk 8 via the seal gap 13. The sealing lip 18 forms the first lip of a seal arrangement of the seal set 7 comprising a total of three elastic sealing lips, which are correspondingly formed from the sealing material 16. The middle, axially running sealing lip 22 is supported by the annular flange 6 through rubbing contact on an inner radius 24. The other non-rubbing sealing lip 23 is oriented radially inwards. To sum up, the invention relates to a seal arrangement 2, in which in service, the centrifugal disk 8 serves to deflect both water and dirt particles radially so as to keep these away from the seal gap 13 of the seal labyrinth 9.

FIG. 2 to FIG. 5 illustrate alternative embodiments of seal arrangements according to the invention, the same reference numerals being used for corresponding components. The following descriptions are substantially confined to configurations that deviate from the exemplary embodiment in FIG. 1.

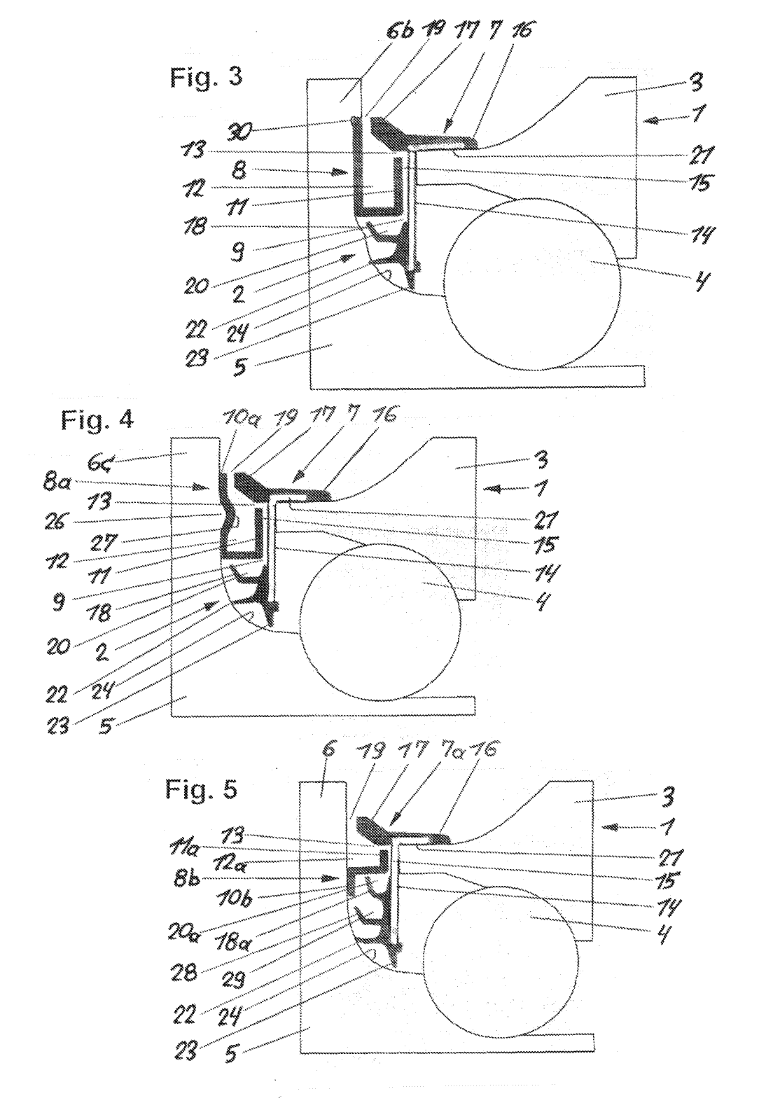

According to FIG. 2 the annular flange 6a adjoining the inner radius 24 forms a circumferential step 25, on which the centrifugal disk 8 is supported. A defined fitting position of the centrifugal disk 8 can thereby be achieved. In order to avoid a sharp-edged transition, a rounded transition 31 to the annular flange 25 adjoins the step 25. FIG. 3 shows the annular flange 6b, which encloses a recess 30, into which the leg 10 of the centrifugal disk 8 is fitted with a positive interlock. The annular flange 6c according to FIG. 4 forms an axially projecting formed attachment 26, which engages by positive interlock in a corresponding formation 27 of the leg 10a of the centrifugal disk 8a. FIG. 5 shows the centrifugal disk 8b, in which the edge 11a and the leg 10b are radially oriented in opposite directions. The seal set 7a further comprises a total of four sealing lips. Complementing the construction according to the exemplary embodiments in FIG. 1 to FIG. 4, FIG. 5 shows two non-rubbing, largely axially oriented sealing lips 18a, 28, which each form a collecting channel 20a, 29. The catch groove 12a of the centrifugal disk 8b here is axially defined by the edge 11a and the annular flange 6.

### LIST OF REFERENCE NUMERALS

1 wheel bearing
2 seal arrangement
3 bearing part (first)
4 rolling element
5 bearing part (second)
6 annular flange
6a annular flange
6b annular flange
6c annular flange
7 seal set
7a seal set
8 centrifugal disk
8a centrifugal disk
8b centrifugal disk
9 seal labyrinth
10 leg
10a leg
10b leg
11 edge
11a edge
12 catch groove
12a catch groove
13 seal gap
14 reinforcement
15 socket
16 sealing material
17 projection
18 sealing lip
18a sealing lip
19 annular gap
20 collecting channel
20a collecting channel
21 portion
22 sealing lip
23 sealing lip
24 inner radius
25 step
26 formed attachment
27 formation
28 sealing lip
29 collecting channel
30 recess
31 transition

1. A seal arrangement of a wheel bearing, which is inserted between a first bearing part and a second bearing part of the wheel bearing, the seal arrangement comprising a pre-seal embodied as a centrifugal disk, and a seal set comprising sealing lips together with a reinforcement, the seal set is connected to the first bearing part via the reinforcement which forms a socket, which is radially defined by an elastic sealing material, and in which a radial edge of the centrifugal disk, which is fixed to the second bearing part and forming which forms a catch groove, engages in the socket while maintaining a seal gap with a degree of play in relation to the seal set, the one-piece centrifugal disk is immovably fixed directly to a radially oriented annular flange of the second, rotatable bearing part by a radial leg and the centrifugal disk forms a seal labyrinth together with the seal set.

2. The seal arrangement as claimed in claim 1, wherein the centrifugal disk has a U-shaped cross sectional profile, and the radial leg together with the radial edge arranged parallel axially define the catch groove.

3. The seal arrangement as claimed in claim 1, wherein the centrifugal disk forms a Z-shaped cross sectional profile, the radial leg is oriented in opposition to the radial edge of the centrifugal disk and the catch groove is defined by the annular flange of the second bearing part and the radial edge of the centrifugal disk.

4. The seal arrangement as claimed in claim 1, wherein in order to form the seal labyrinth, the radial edge of the centrifugal disk, while maintaining a seal gap, engages in the socket of the seal set defined by the elastic sealing material.

5. The seal arrangement as claimed in claim 1, wherein the radial leg of the centrifugal disk is immovably fixed to the annular flange of the second bearing part by a cohesive material connection or by a positive interlock.

6. The seal arrangement as claimed in claim 1, wherein for centering and fixing, the centrifugal disk is fitted into a recess or to a step of the annular flange of the second bearing part.

7. The seal arrangement as claimed in claim 1, wherein the annular flange of the second bearing part locally comprises at least one projecting formed attachment, which engages by positive interlock in a corresponding formation of the leg of the centrifugal disk.

8. The seal arrangement as claimed in claim 1, wherein the reinforcement of the seal set is covered on one side, at least in some areas, by a sealing material, from which projecting, elastic sealing lips or a projection are formed.

9. The seal arrangement as claimed in claim 8, wherein a first axially oriented projection of the seal set on an opening side of the catch groove is taken up to an annular gap on the annular flange of the first bearing part, and the seal set, with a radial offset in relation to the projection, forms at least three sealing lips formed from the sealing material, of which at least one of the sealing lips is supported by rubbing contact on the second bearing part, and at least one further axially running non-rubbing one of the sealing lips forms a collecting channel downstream of the catch groove, and at least one radially oriented, non-rubbing one of the sealing lips is assigned to an axial portion of the second, rotatable bearing part.

10. The seal arrangement as claimed in claim 1, wherein the centrifugal disk is produced from a metallic material or a plastic.
